(19) United States
(12) Patent Application Publication
(10) Pub. No.: US 2026/0367589 A1
(43) Pub. Date: Nov. 19, 2026

(54) BUILDING AUTOMATION SYSTEM MANAGEMENT

(71) Applicant: Honeywell International Inc., Charlotte, NC (US)

(72) Inventors: Vidya Shivamurthy, Mechanicsville, VA (US); Amod Kamat, Glen Allen, VA (US); Daniel Giorgis, Glen Allen, VA (US); Mithun Tiruvedula, Glen Allen, VA (US)

(21) Appl. No.: 19/208,602

(22) Filed: May 15, 2025

(51) Int. Cl. G05B 13/02

(52) U.S. Cl. CPC G05B 13/027

(57) ABSTRACT

Techniques for facilitating management of Building Automation Systems (BAS) are described. In operation, a query related to a building services system from amongst a plurality of building services systems present within a premises is received. The BAS may control operations of the plurality of building services systems. A query type corresponding to the query is then determined. Based on the determined query type, a set of data sources comprising query resolution data related to the building services system is identified, where the query resolution data is usable for determining a response to the query. The query resolution data related to the building services system is then retrieved from the set of data sources. The query resolution data is then analysed with respect to the query using a Large Language Model (LLM) for determining the response to the query. Subsequently, the response to the query is returned.

### BACKGROUND

Building premises today are equipped with a variety of building services systems that are designed to ensure that occupants remain comfortable, safe, and productive. Such systems form the backbone of modern infrastructure and include, but are not limited to, heating, ventilation, and air conditioning (HVAC) systems, lighting systems, water supply and plumbing systems, power distribution networks, fire safety systems, and security and surveillance systems. Collectively, these services regulate temperature, air quality, lighting levels, water availability, and safety, thereby directly impacting the comfort and well-being of occupants.

### BRIEF DESCRIPTION OF DRAWINGS

FIG. 1 illustrates an environment for facilitating management of a Building Automation System (BAS), in accordance with an example of the present subject matter.

FIG. 2 illustrates a schematic of the BAS, in accordance with an example of the present subject matter.

FIG. 3 illustrates the schematic of the BAS, in accordance with another example of the present subject matter.

FIG. 4 illustrates a method for facilitating management of BAS, in accordance with an example of the present subject matter.

FIG. 5 illustrates the method for facilitating management of BAS, in accordance with another example of the present subject matter.

FIG. 6 illustrates the method for facilitating management of BAS, in accordance with yet another example of the present subject matter.

FIGS. 7A and 7B illustrate the method for facilitating management of BAS, in accordance with yet another example of the present subject matter.

FIGS. 8A and 8B illustrate the method for facilitating management of BAS, in accordance with yet another example of the present subject matter.

FIG. 9 illustrates a non-transitory computer-readable medium for facilitating management of the BAS, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

To maintain optimal comfort levels, the building services systems operate harmoniously and respond dynamically to both environmental conditions and user requirements. For example, HVAC systems adjust heating and cooling parameters based on occupancy patterns and external weather conditions, while lighting systems automatically modify brightness levels based on daylight availability and time of day.

In modern infrastructures, the operation and coordination of the building services systems are typically managed by a centralized Building Automation System (BAS). A BAS monitors, controls, and optimizes the various systems through a network of sensors, controllers, and actuators. By collecting real-time data, the BAS can make intelligent decisions, such as adjusting air circulation or lighting levels, to enhance energy efficiency and ensure occupant comfort without manual intervention.

While BAS platforms are largely automated, there are numerous scenarios where human intervention becomes necessary. For example, when a specific subsystem, such as an air handling unit (AHU), exhibits irregular behaviour, e.g., fluctuating temperatures or air pressure anomalies, the BAS may not be capable of diagnosing or resolving the issue without input from an operator. In such cases, an operator may analyze system logs, sensor data, and operational trends to identify the root cause and implement corrective actions.

The operator is typically well-versed in the technical specifications of the various building services systems and understands how the BAS orchestrates their operation. More importantly, the operator possesses procedural knowledge on how to approach and resolve faults when they arise. Such knowledge is generally acquired over time, often through hands-on experience, on-the-job training, exposure to historical fault cases, and collaboration with senior personnel. Accordingly, the expertise level of operators can vary significantly based on their length and depth of experience. A seasoned operator may have intimate familiarity with the subtle behaviours of systems and the most efficient resolution pathways for recurring issues.

A significant challenge arises when such an experienced operator retires or otherwise leaves the organization. The incoming operator, often in the early stages of training, may not yet possess the same depth of understanding of the BAS and building services systems. When confronted with a troubleshooting scenario during this learning phase, the new operator is typically forced to consult extensive technical documentation for guidance.

Such traditional methods of knowledge acquisition and problem-solving are inefficient, time-consuming, and unreliable. They require significant effort from the operator and may not guarantee a resolution, especially when the issue is complex or unprecedented. This inefficiency not only delays the restoration of optimal system performance but also undermines the capabilities of the building automation system, which depends on timely and accurate human input in exceptional scenarios. As a result, the potential of the BAS and the building services systems is not fully realized, leading to degraded occupant comfort, increased energy consumption, and extended downtime of critical services.

According to examples of the present subject matter, techniques for facilitating management of Building Automation Systems (BAS) are described.

In an example, a query related to a building services system from amongst a plurality of building services systems present within a premises is received. The BAS may control operations of the plurality of building services systems.

A query type corresponding to the query is then determined. Based on the determined query type, a set of data sources comprising query resolution data related to the building services system is identified, where the query resolution data is usable for determining a response to the query.

The query resolution data related to the building services system is then retrieved from the set of data sources. The query resolution data may vary based on the set of data sources identified based on the query type and may include at least one of: technical specification related to the building services system, community Q&A corresponding to the building services system comprising empirical queries related to the building services system and responses to the empirical queries, developer documentation associated with the BAS comprising developer comments related to a plurality of features of the BAS, and a preliminary response to the query generated by a service help desk corresponding to the BAS.

The query resolution data related to the building services system is then analysed with respect to the query using a Large Language Model (LLM) for determining the response to the query. Subsequently, the response to the query is returned.

By leveraging the LLM to analyse the query resolution data retrieved from the set of data sources that are dynamically identified based on the query type, the present subject matter enables operators to rapidly access comprehensive and context-aware solutions, regardless of their experience levels. Further, by integrating diverse knowledge sources, such as technical specifications, community insights, developer documentation, and help desk responses, the present subject matter bridges the expertise gap that often hinders optimal performance of the BAS and the multiple building services systems controlled by the BAS.

Consequently, the present subject matter allows for faster and more accurate problem resolution, thereby enabling the BAS to operate closer to its full potential, maintaining optimal occupant comfort, energy efficiency, and service reliability, even when faced with complex issues or when operated by less experienced staff.

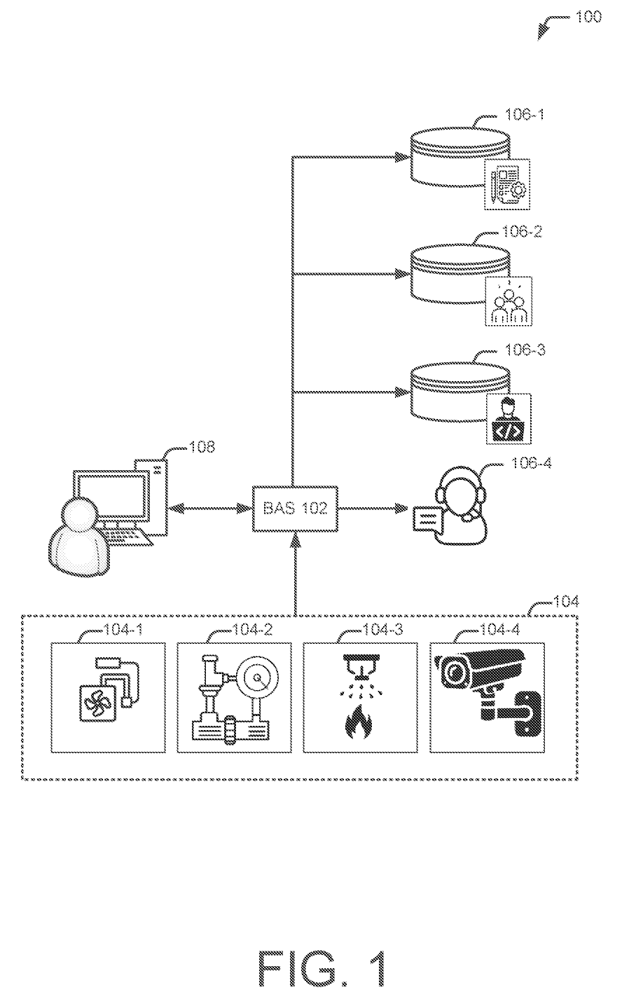

The above techniques are further described with reference to FIGS. 1-9. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an environment 100 for facilitating management of a Building Automation System (BAS), in accordance with an example of the present subject matter.

In an example, the environment 100 may include the BAS 102. The BAS 102 may control operations of the plurality of building services systems 104 present within a premises, amongst other functions. The plurality of the building services systems 104 may include, but are not limited to, heating, ventilation, and air conditioning (HVAC) systems 104-1, water supply and plumbing systems 104-2, fire safety systems 104-3, and security and surveillance systems 104-4.

To control the operations of the plurality of the building services systems 104, the BAS 102 may utilize a network of sensors, controllers, and actuators distributed throughout the premises. Examples of the sensors may include, but is not limited to, temperature sensors, humidity sensors, occupancy sensors, air quality sensors, and energy consumption meters. In operation, the BAS 102 may collect and process real-time data from the sensors to make intelligent decisions about the operations of the plurality of the building services systems 104. Further, the BAS 102 may employ various algorithms and control strategies to optimize the performance of each building services system. For example, the BAS 102 may adjust HVAC settings based on occupancy patterns, weather forecasts, and thermal load predictions. Similarly, the BAS 102 may control the lighting systems to adjust illumination levels based on natural light availability and occupancy.

The environment may further include a plurality of data sources 106-1, 106-2, 106-3, and 106-4 coupled to the BAS 102. For the ease of reference, the plurality of data sources 106-1, 106-2, 106-3, and 106-4 have been referred to as the plurality of data sources 106, hereinafter. The plurality of data sources may include multifaceted data pertaining to the plurality of building services systems 104 that may facilitate determination of a response to the query.

For instance, the plurality of data sources 106 may include a first database 106-1 including technical specifications related to the plurality of building services systems 104. The technical specifications may include information about components, operational parameters, performance metrics, maintenance schedules, and compatibility requirements of the plurality of the building services systems 104. The first database 106-1 may store detailed manufacturer specifications, installation guides, and troubleshooting manuals for each of the plurality of building services system. The plurality of data sources 106 may further include a second database 106-2 comprising community Q&A data corresponding to the plurality of building services systems 104. The community Q&A data may include empirical queries related to the plurality of building services systems and responses to the empirical queries. For instance, the second database 106-2 may contain user-submitted questions about a building service system’s behaviour, error codes, or optimization techniques, along with responses from experienced professionals or other community members. The second database 106-2 may also include case studies of successful problem resolutions and best practices shared by facility managers and technicians. Further, the plurality of data sources 106 may include a third database 106-3 comprising developer documentation associated with the BAS 102. The developer documentation may include developer comments related to a plurality of features of the BAS 102. For instance, the third database 106-3 may contain detailed explanations of BAS algorithms, API documentation, integration guides, and release notes for various BAS versions. The third database 106-3 may also include code snippets, configuration examples, and developer insights into system architecture and future roadmaps. Moreover, the plurality of data sources 106 may include a service help desk 106-4. The service help desk 106-4 may be configured to receive and process support requests from operators, generate preliminary responses based on common issues and known solutions, and maintain a record of all support interactions. The help desk may utilize a ticketing system to track and prioritize issues and may have access to remote diagnostic tools to assist in troubleshooting BAS and building services system problems.

The environment 100 may further include a workbench 108 associated with the BAS 102. In an example, the workbench 108 may be coupled to the BAS 102 and the plurality of building services systems 104 coupled to the BAS 102. The workbench 108, amongst other functions, may serve as an interface between the BAS 102 and an associated operator for facilitating management of the operation of the BAS 102 and the plurality of building services systems 104 coupled to the BAS 102.

In operation, the BAS 102 may receive a query related to a building services system, such as building services system 104-1, from amongst a plurality of building services systems 104 present within the premises. In an example, the BAS 102 may receive the query from the workbench 108.

The BAS 102 may then determine a query type corresponding to the query. The BAS may then identify a set of data sources from amongst the plurality of data sources 106 based on the query type. The set of data sources may include query resolution data related to the building services system, where the query resolution data is usable for determining a response to the query.

The BAS 102 may then retrieve the query resolution data related to the building services system from the set of data sources. In an example, the query resolution data may vary based on the set of data sources identified based on the query type and include at least one of: technical specification related to the building services system, community Q&A corresponding to the building services system comprising empirical queries related to the building services system and responses to the empirical queries, developer documentation associated with the BAS 102 comprising developer comments related to a plurality of features of the BAS 102, and a preliminary response to the query generated by the service help desk corresponding to the BAS 102.

The BAS 102 may then analyse the query resolution data related to the building services system with respect to the query using a Large Language Model (LLM) for determining the response to the query. Subsequently, the BAS 102 may return the response to the query. In an example, the BAS 102 may return the response to the query to the workbench 108. The response to the query may be a recommendation for resolving an issue related to the building services systems, such as equipment malfunctions, performance inefficiencies, or operational anomalies. In the example, the operator may apply the recommended solution, which may include adjusting operating parameters of the building services systems, recalibrating sensors, modifying control algorithms, or initiating maintenance procedures, through the workbench 108. The manner in which the management of the BAS 102 is facilitated is further described in conjunction with the forthcoming figures.

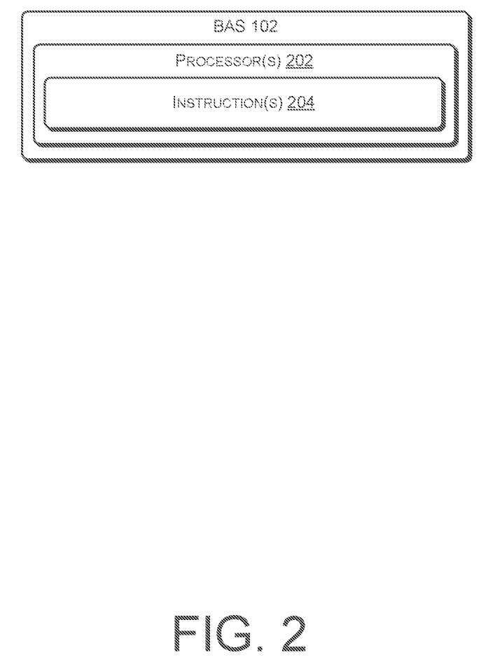

FIG. 2 illustrates a schematic of the BAS 102, in accordance with an example of the present subject matter.

The BAS 102 may include a processor 202. The processor 202 may fetch and execute the computer-readable instructions 204 stored in a memory (not depicted in FIG. 2), to control operations of the plurality of building services systems 104 present within the premises, amongst other functions.

In an example, the processor 202 may cause the BAS 102 to receive a query related to the building services system 104-1 present within the premises. The processor 202 may then cause the BAS 102 to determine a query type corresponding to the query. The processor 202 may then cause the BAS 102 to identify a set of data sources from amongst the plurality of data sources 106 based on the query type. The set of data sources may include query resolution data related to the building services system, where the query resolution data is usable for determining a response to the query.

The processor 202 may then cause the BAS 102 to retrieve the query resolution data related to the building services system from the set of data sources. In an example, the query resolution data may vary based on the set of data sources identified based on the query type and include at least one of: technical specification related to the building services system, community Q&A corresponding to the building services system comprising empirical queries related to the building services system and responses to the empirical queries, developer documentation associated with the BAS 102 comprising developer comments related to a plurality of features of the BAS 102, and a preliminary response to the query generated by the service help desk corresponding to the BAS 102.

The processor 202 may then cause the BAS 102 to analyse the query resolution data related to the building services system with respect to the query using a LLM for determining the response to the query. Subsequently, the processor 202 may cause the BAS 102 to return the response to the query. In an example, the processor 202 may cause the BAS 102 to return the response to the query to the workbench 108. The response to the query may be a recommendation for resolving an issue related to the building services systems, such as equipment malfunctions, performance inefficiencies, or operational anomalies. In the example, the operator may apply the recommended solution, which may include adjusting operating parameters of the building services systems, recalibrating sensors, modifying control algorithms, or initiating maintenance procedures, through the workbench 108.

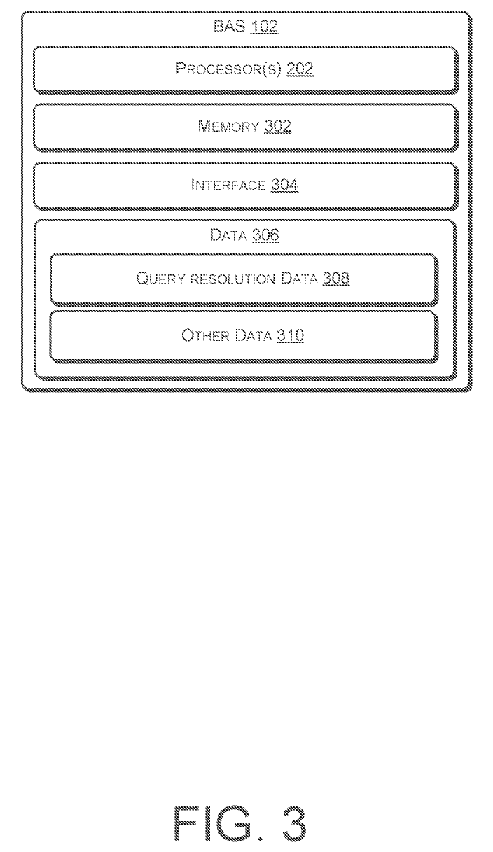

FIG. 3 illustrates the schematic of the BAS 102, in accordance with another example of the present subject matter.

The BAS 102 may include the processor 202, a memory 302, and an interface 304 coupled to the memory 302. The functions of various elements shown in the figs., including any functional blocks labelled as “processor”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly comprise, without limitation, digital signal processor (DSP) hardware, network processor, application specific integrated circuit (ASIC), field programmable gate array (FPGA). Other hardware, standard and/or custom, may also be coupled to the processor.

The memory 302 may be a computer-readable medium, examples of which comprise volatile memory (e.g., RAM), and/or non-volatile memory (e.g., Erasable Programmable read-only memory, i.e., EPROM, flash memory, etc.). The memory 302 may be an external memory, or internal memory, such as a flash drive, a compact disk drive, an external hard disk drive, or the like. The memory 302 may further comprise data which either may be utilized or generated during the operation of the BAS 102.

The interface 304 may allow the connection or coupling of the BAS 102 with one or more other devices, through a wired (e.g., Local Area Network, i.e., LAN) connection or through a wireless connection (e.g., Bluetooth®, WiFi). The interface 304 may also enable intercommunication between different logical as well as hardware components of the BAS 102.

The BAS 102 may further include data 306 that may be utilized or generated by the processor 202 while performing a variety of functions. In an example, the data 306 includes query resolution data 308 and other data 310. The other data 310, amongst other things, may serve as a repository for storing data that is processed, received, or generated as a result of the execution of the instructions by the processor 202. In an example, the data 306 may be stored in the memory 302.

In operation, the processor 202 may cause the BAS 102 to receive a query related to a building services system, such as building services system 104-1, from amongst a plurality of building services systems 104 present within the premises. The BAS 102 may receive the query from the workbench 108. In an example, the query may be for determining a command sequence to be implemented on the BAS 102 for controlling the building services system.

The processor 202 may then cause the BAS 102 to determine a query type corresponding to the query. In an example, the query type may include at least one of: conceptual query and instructional query. In the example, the conceptual query may relate to the technical specification of the building services system. For instance, a conceptual query might ask about the maximum capacity of an HVAC system, the energy efficiency rating of a particular lighting system, or the technical requirements for integrating a new security subsystem with the existing BAS. Further, the instructional query may relate to the operation of the building services system. For instance, an instructional query might ask for steps to recalibrate temperature sensors, procedures for updating the BAS software, or methods to optimize the energy consumption of the water heating system during off-peak hours.

The query type may also include various other queries related to troubleshooting, maintenance, optimization, and system integration. For instance, a troubleshooting query might ask about diagnosing and resolving intermittent failures in the fire alarm system, a maintenance query could request the recommended schedule for replacing air filters in the HVAC system, an optimization query might seek ways to reduce energy consumption of the lighting system during daylight hours, and a system integration query could ask about the process of connecting a new smart thermostat to the existing BAS network.

In an example, prior to determining the query type, the processor 202 may cause the BAS 102 to augment the query. The processor 202 may cause the BAS 102 to augment the query based on various known query augmentation techniques, such as query expansion and semantic analysis. For instance, the query expansion may involve adding synonyms or related terms to broaden the scope of the query. Further, the semantic analysis may be used to understand the intent behind the query and add relevant concepts.

The processor 202 may further cause the BAS 102 to augment the query based on a context of the query to generate an augmented query. In the example, the processor 202 may cause the BAS 102 to determine the context based on a user profile of the operator of the workbench 108. For instance, if the user profile indicates that the operator specializes in HVAC systems, the processor 202 may cause the BAS 102 to augment the query with HVAC-specific terms and parameters, even if the original query was more general. This could help retrieve more relevant information from the technical databases. If the profile shows the operator frequently works night shifts, the processor 202 may cause the BAS 102 to augment the query with terms related to off-peak operations or night-time energy efficiency strategies.

The processor 202 may then cause the BAS 102 to identify a set of data sources including query resolution data related to the building services system. The query resolution data may be usable for determining a response to the query. The processor 202 may cause the BAS 102 to identify the set of data sources based on the query type. For instance, when the processor 202 identifies the query type to be the conceptual query, the processor 202 may determine the set of data sources to include at least one of the first database 106-1 including the technical specification related to the building services system, the third database 106-3 including the developer documentation associated with the BAS, and the service help desk 106-4. On the other hand, when the processor 202 identifies the query type to be the instructional query, the processor 202 may determine the set of data sources to include at least one of the second database 106-2 including the empirical queries related to the building services system and responses to the empirical queries, the third database 106-3 including the developer documentation associated with the BAS, and the service help desk 106-4.

The processor 202 may then cause the BAS 102 to retrieve query resolution data from the set of data sources. As already explained, the query resolution data may vary based on the set of data sources identified based on the query type and include at least one of: technical specification related to the building services system, community Q&A corresponding to the building services system comprising empirical queries related to the building services system and responses to the empirical queries, developer documentation associated with the BAS 102 comprising developer comments related to a plurality of features of the BAS 102, and a preliminary response to the query generated by the service help desk corresponding to the BAS 102. In an example, the processor 202 may then cause the BAS 102 to store the query resolution data in the query resolution data 308.

The processor 202 may then cause the BAS 102 to analyze the query resolution data related to the building services system with respect to the query using a Large Language Model (LLM). The LLM may process the query resolution data to extract relevant information, identify patterns, and generate a coherent response to the query. The processor 202 may cause the BAS 102 to analyse the query resolution data for determining the response to the query.

It would be noted that by employing a dynamic and adaptive approach to data source selection and query resolution, the present subject matter offers significant advantages over conventional mechanisms for resolution of user queries. The processor 202 causes the BAS 102 to intelligently identify and retrieve information from multiple, specialized data sources based on the query type, be it conceptual or instructional. For conceptual queries, the processor 202 causes the BAS 102 to prioritize technical specifications and developer documentation, while for instructional queries, the processor 202 causes the BAS 102 to focus on empirical data and community-sourced solutions. Such a targeted approach ensures that the most relevant and up-to-date information for each specific query is accessed. As a result, the present subject matter not only reduces noise in the response generation process but also enhances the efficiency and accuracy of query resolution, providing users with more precise and contextually appropriate answers in the complex domain of building automation systems.

In an example, the BAS 102 may receive the query: "How do I adjust the air flow rate in conference room A?". The query may be received from an operator at the workbench 108. The BAS 102 may determine the query type corresponding to the query to be an instructional query. Based on this query type, the BAS may identify relevant data sources to include the first database comprising the technical specification of the HVAC system and the second database 106-2 comprising the community Q&A.

Thereafter, the BAS 102 may retrieve the query resolution data from these data sources, which may include: similar questions and answers from the community Q&A and step-by-step instructions for adjusting air flow rates from the technical specification.

The BAS 102 may then analyze the query resolution data using the LLM to determine a response to the query. In an example, the response may include:
To adjust the air flow rate in conference room A:
1. Access the BAS control panel
2. Navigate to the HVAC section
3. Select 'Conference Room A' from the zone list
4. Locate the 'Air Flow Rate' parameter
5. Use the slider or input field to adjust the rate
6. Confirm changes and monitor the room's conditions
Note: Optimal air flow rate may vary based on occupancy and external weather conditions. Consider using the 'Auto-Adjust' feature for dynamic control.

The BAS 102 may then return the response to the operator via the workbench 108, providing clear instructions while also offering additional context and suggestions.

In an example, upon analysis of the query resolution data using the LLM, the processor 202 may determine that, in addition to the query resolution data retrieved from the set of data sources, at least one of an operational parameter associated with the building services system and logs associated with the operational parameter are required for determining the response to the query. For instance, if the query relates to an unexpected temperature fluctuation in a specific zone of the building, the processor 202 may identify that current temperature readings, historical temperature data, and HVAC system operational logs are required to provide a comprehensive response. In such a situation, the processor 202 may cause the BAS 102 to request the workbench 108 for operational parameters and logs for the HVAC system. The operational parameters may include current temperature setpoints, fan speeds, and valve positions of the HVAC system serving the affected zone. The logs may contain information about recent maintenance activities, system changes, or fault alerts that could be relevant to the temperature issue. Once the operational parameters and logs are received, the processor 202 may update the query resolution data by incorporating this new information.

The processor 202 may then cause the BAS 102 to reanalyse the updated query resolution data using the LLM. By incorporating the real-time and historical operational data, a more accurate and context-aware response to the query may be provided, potentially identifying patterns or anomalies that may not be apparent from the static query resolution data alone. Accordingly, the BAS 102 may be enabled to leverage both its extensive knowledge base and current operational data to generate comprehensive and relevant responses to complex queries about building system performance.

In such a situation, the processor 202 may cause the BAS 102 to transmit a request to the workbench for at least one of the operational parameter and the logs associated with the operational parameter.

In the example, in response to the request, the workbench 108 may query the network of sensors, controllers, and actuators associated with the BAS 102 and the building services system and retrieve at least one of the operational parameter and the logs associated with the operational parameter. The workbench 108 may then transmit the at least one of the operational parameter and the logs associated with the operational parameter to the BAS 102.

The processor 202 may then cause the BAS 102 to receive at least one of the operational parameter and the logs associated with the operational parameter. Thereafter, the processor 202 may cause the BAS 102 to update the query resolution data by including at least one of the operational parameter and the logs associated with the operational parameter to generate updated query resolution data. Subsequently, the processor 202 may cause the BAS 102 to analyze the updated query resolution data with respect to the query using the LLM for determining the response to the query.

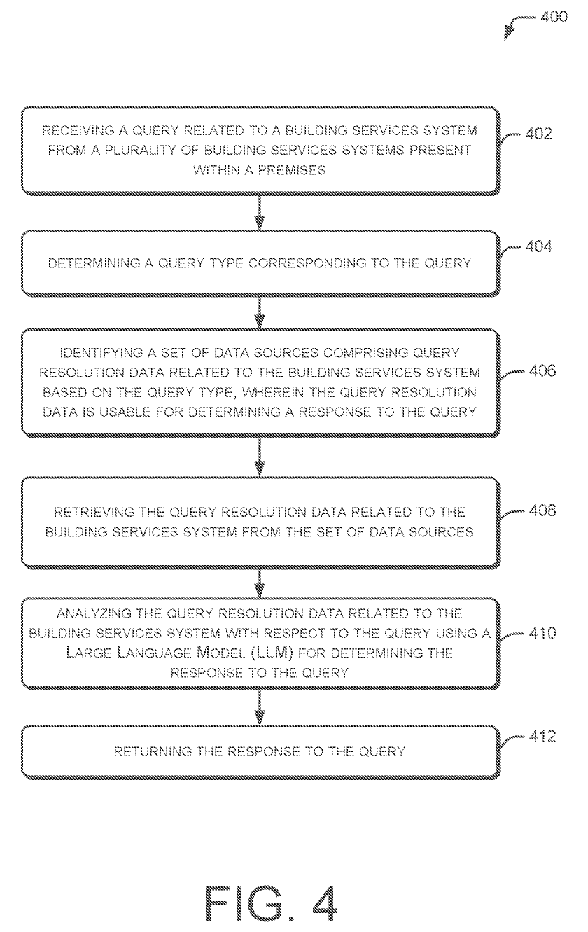

FIGS. 4, 5, 6, 7, and 8 illustrate methods for facilitating management of BAS, in accordance with examples of the present subject matter. The order in which the method steps are described is not intended to be construed as a limitation, and any number of the described method blocks may be combined in any order to implement the methods, or an alternative method. Further, the methods 400, 500, 600, 700, and 800 may be implemented by processing resource or computing device(s) through any suitable hardware, non-transitory machine-readable instructions, or combination thereof.

It may also be understood that methods 400, 500, 600, 700, and 800 may be performed by programmed computing devices, such as the BAS 102. Furthermore, the methods 400, 500, 600, 700, and 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 400, 500, 600, 700, and 800 are described below with reference to the BAS 102, as described above; other suitable systems for the execution of these methods may also be utilized. Additionally, implementation of the method is not limited to such examples.

FIG. 4 illustrates a method for facilitating management of BAS, in accordance with an example of the present subject matter.

At block 402, a query related to a building services system from a plurality of building services systems present within a premises is received. The BAS may control operations of the plurality of building services systems. To control the operations of the plurality of the building services systems, the BAS may utilize a network of sensors, controllers, and actuators distributed throughout the premises. The BAS may collect and process real-time data from the sensors to make intelligent decisions about the operations of the plurality of the building services systems. Further, the BAS may employ various algorithms and control strategies to optimize the performance of each building services system.

In an example, the query may be received for determining a command sequence to be implemented on the BAS for controlling the building services system.

At block 404, a query type corresponding to the query is determined. The query type may comprise at least one of: conceptual query and instructional query. A conceptual query may relate to the technical specification of the building services system. For example, a conceptual query might ask about the maximum capacity of an HVAC system, the energy efficiency rating of a particular lighting system, or the technical requirements for integrating a new security subsystem with the existing BAS. An instructional query may relate to the operation of the building services system. For instance, an instructional query might ask for steps to recalibrate temperature sensors, procedures for updating the BAS software, or methods to optimize the energy consumption of the water heating system during off-peak hours.

At block 406, a set of data sources comprising query resolution data related to the building services system is identified based on the query type. In an example, the query resolution data may be usable for determining a response to the query.

At block 408, the query resolution data related to the building services system is retrieved from the set of data sources. The query resolution data may comprise at least one of: technical specification related to the building services system, community Q&A corresponding to the building services system comprising empirical queries related to the building services system and responses to the empirical queries, developer documentation associated with the BAS comprising developer comments related to a plurality of features of the BAS, and a preliminary response to the query generated by a service help desk corresponding to the BAS. For example, if the query relates to a specific HVAC component, the retrieved query resolution data may include the technical specifications of that component from manufacturer documentation, relevant questions and answers from a community forum discussing similar issues, comments from BAS developers explaining the integration of that component with the system, and any preliminary troubleshooting steps suggested by the BAS help desk for common issues with that component.

At block 410, the query resolution data related to the building services system is analyzed with respect to the query using a Large Language Model (LLM) for determining the response to the query.

At block 412, the response to the query is returned.

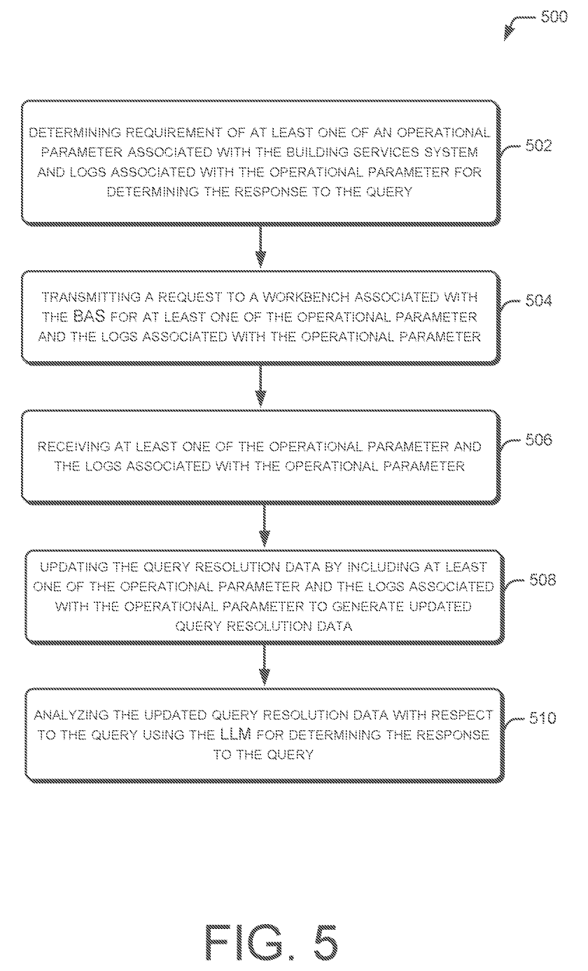

FIG. 5 illustrates a method for facilitating management of BAS, in accordance with another example of the present subject matter. In an example, the method 500 may be implemented if it is determined that the query resolution data retrieved from the set of data sources is insufficient to provide a comprehensive response to the query. For instance, if the query relates to an unexpected temperature fluctuation in a specific zone of the building, current temperature readings, historical temperature data, and HVAC system operational logs may be necessary to provide an accurate and context-aware response.

At block 502, a requirement of at least one of an operational parameter associated with the building services system and logs associated with the operational parameter for determining the response to the query is determined.

At block 504, a request is transmitted to a workbench associated with the BAS for at least one of the operational parameter and the logs associated with the operational parameter.

At block 506, at least one of the operational parameter and the logs associated with the operational parameter is received.

At block 508, the query resolution data is updated by including at least one of the operational parameter and the logs associated with the operational parameter to generate updated query resolution data.

At block 510, the updated query resolution data is analysed with respect to the query using the LLM for determining the response to the query.

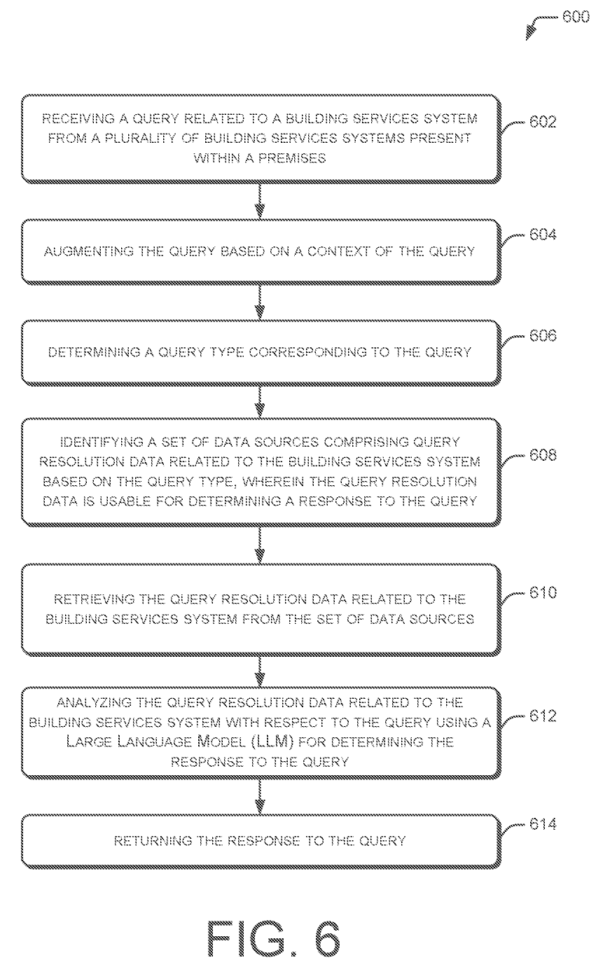

FIG. 6 illustrates a method 600 for facilitating management of a Building Automation System (BAS), in accordance with an example of the present subject matter.

At block 602, a query related to a building services system from a plurality of building services systems present within a premises is received. The BAS may control operations of the plurality of building services systems.

At block 604, the query is augmented based on a context of the query. In an example, the query may be received from an operator corresponding to a workbench associated with the BAS, and the context of the query may be determined based on a user profile of the operator. For instance, if the user profile indicates that the operator specializes in HVAC systems, the query may be augmented with HVAC-specific terms and parameters, even if the original query was more general. This could help retrieve more relevant information from the technical databases. If the profile shows the operator frequently works night shifts, the query may be augmented with terms related to off-peak operations or night-time energy efficiency strategies.

At block 606, a query type corresponding to the query is determined.

At block 608, a set of data sources comprising query resolution data related to the building services system is identified based on the query type. In an example, the query resolution data may be usable for determining a response to the query.

At block 610, the query resolution data related to the building services system is retrieved from the set of data sources.

At block 612, the query resolution data related to the building services system is analyzed with respect to the query using a Large Language Model (LLM) for determining the response to the query.

At block 614, the response to the query is returned.

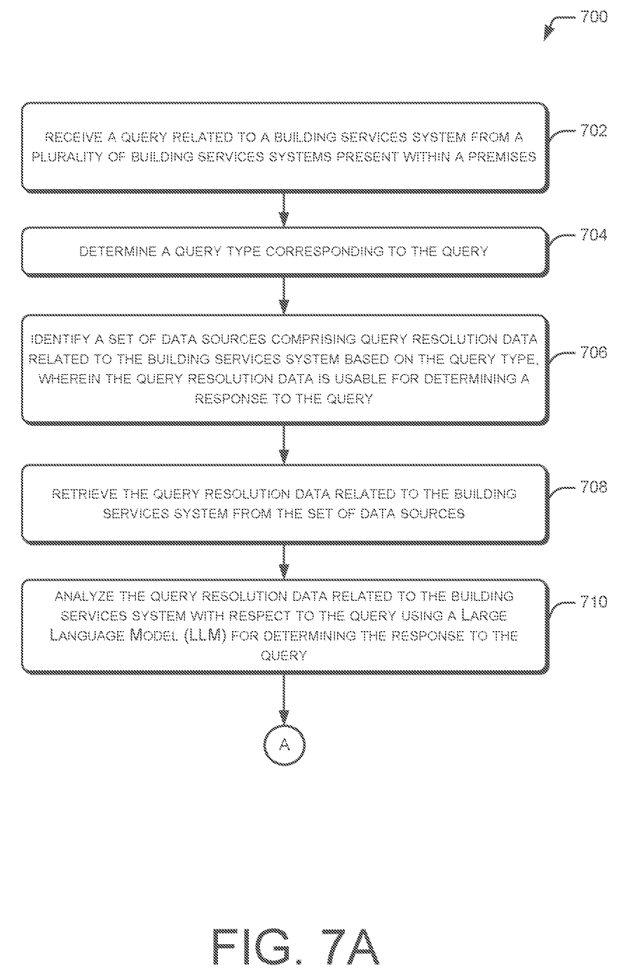

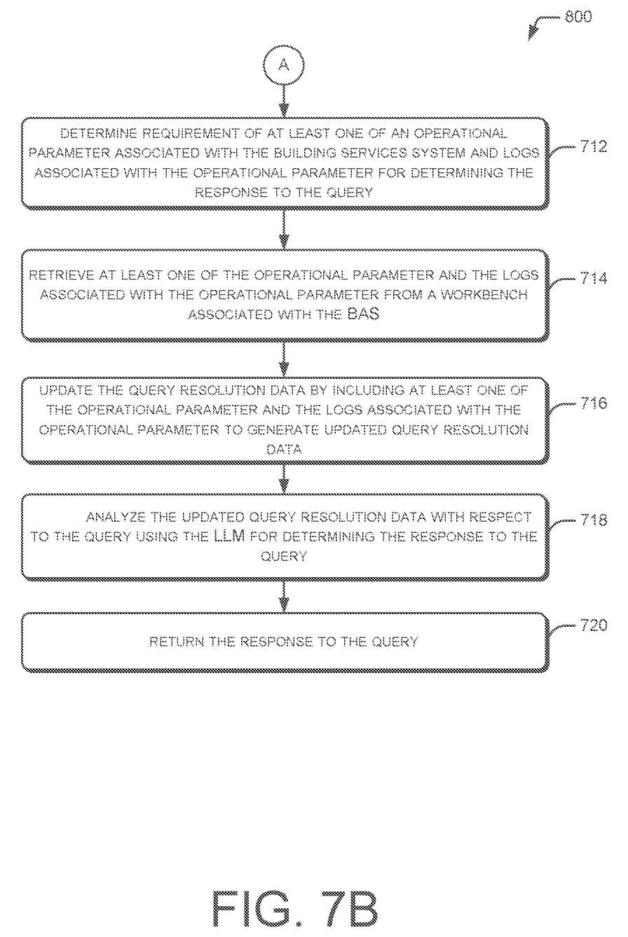

FIGS. 7A and 7B illustrate a method 700 for facilitating management of the BAS, in accordance with yet another example of the present subject matter.

At block 702, a query related to a building services system from a plurality of building services systems present within a premises is received. The BAS may control operations of the plurality of building services systems.

At block 704, a query type corresponding to the query is determined. As already explained, the query type may comprise at least one of: conceptual query and instructional query. A conceptual query may relate to the technical specification of the building services system. Further, an instructional query may relate to the operation of the building services system.

At block 706, a set of data sources comprising query resolution data related to the building services system is identified based on the query type. In an example, the query resolution data may be usable for determining a response to the query.

At block 708, the query resolution data related to the building services system is retrieved from the set of data sources. In an example, the query resolution data may comprise at least one of: technical specification related to the building services system, community Q&A corresponding to the building services system comprising empirical queries related to the building services system and responses to the empirical queries, developer documentation associated with the BAS comprising developer comments related to a plurality of features of the BAS, and a preliminary response to the query generated by a service help desk corresponding to the BAS. For example, if the query relates to a specific HVAC component, the retrieved query resolution data may include the technical specifications of that component from manufacturer documentation, relevant questions and answers from a community forum discussing similar issues, comments from BAS developers explaining the integration of that component with the system, and any preliminary troubleshooting steps suggested by the BAS help desk for common issues with that component.

At block 710, the query resolution data related to the building services system is analysed with respect to the query using a Large Language Model (LLM) for determining the response to the query.

At block 712, a requirement of at least one of an operational parameter associated with the building services system and logs associated with the operational parameter for determining the response to the query is determined. In an example, the requirement may be determined if it is identified that the query resolution data retrieved from the set of data sources is insufficient to provide a comprehensive response to the query. For instance, if the query relates to an unexpected temperature fluctuation in a specific zone of the building, current temperature readings, historical temperature data, and HVAC system operational logs may be necessary to provide an accurate and context-aware response.

At block 714, at least one of the operational parameter and the logs associated with the operational parameter is retrieved from a workbench associated with the BAS.

At block 716, the query resolution data is updated by including at least one of the operational parameter and the logs associated with the operational parameter to generate updated query resolution data.

At block 718, the updated query resolution data is analysed with respect to the query using the LLM for determining the response to the query.

At block 720, the response to the query is returned.

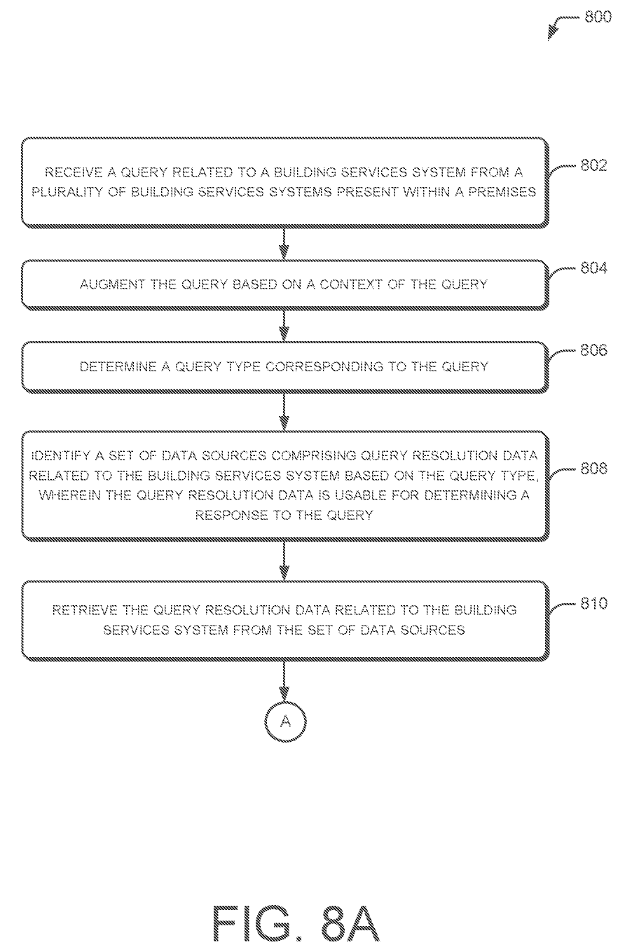

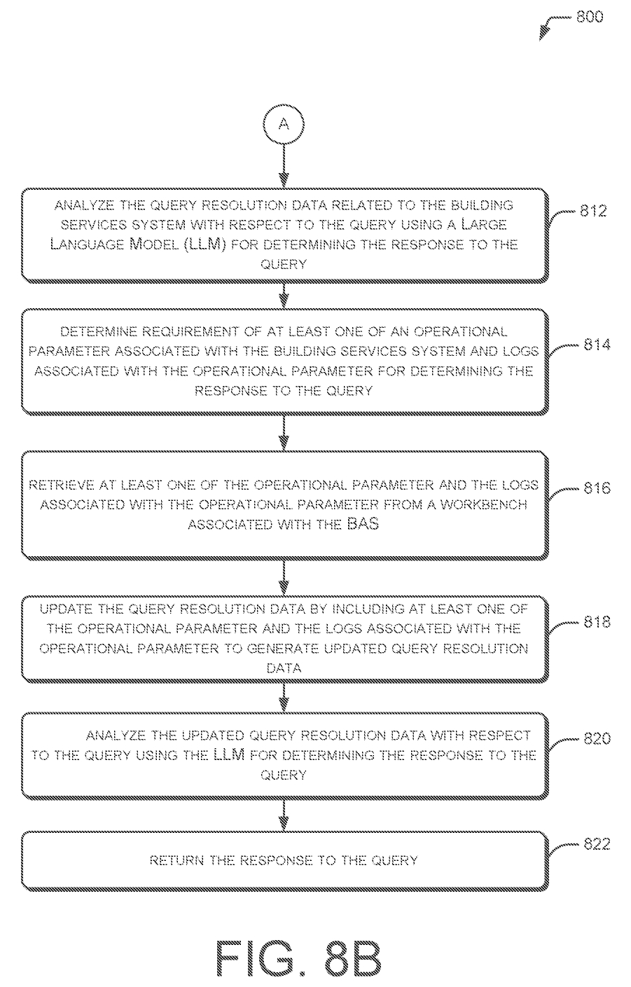

FIG. 8 illustrates a method 800 for facilitating management of the BAS, in accordance with an example of the present subject matter.

At block 802, a query related to a building services system from a plurality of building services systems present within a premises is received. In an example, the BAS may control operations of the plurality of building services systems.

At block 804, the query is augmented based on a context of the query. As already explained, the query may be received from an operator corresponding to a workbench associated with the BAS, and the context of the query may be determined based on a user profile of the operator.

At block 806, a query type corresponding to the query is determined.

At block 808, a set of data sources comprising query resolution data related to the building services system is identified based on the query type. In an example, the query resolution data may be usable for determining a response to the query.

At block 810, the query resolution data related to the building services system is retrieved from the set of data sources.

At block 812, the query resolution data related to the building services system is analysed with respect to the query using a Large Language Model (LLM) for determining the response to the query.

At block 814, a requirement of at least one of an operational parameter associated with the building services system and logs associated with the operational parameter for determining the response to the query is determined.

At block 816, at least one of the operational parameter and the logs associated with the operational parameter is retrieved from a workbench associated with the BAS.

At block 818, the query resolution data is updated by including at least one of the operational parameter and the logs associated with the operational parameter to generate updated query resolution data.

At block 820, the updated query resolution data is analysed with respect to the query using the LLM for determining the response to the query.

At block 822, the response to the query is returned.

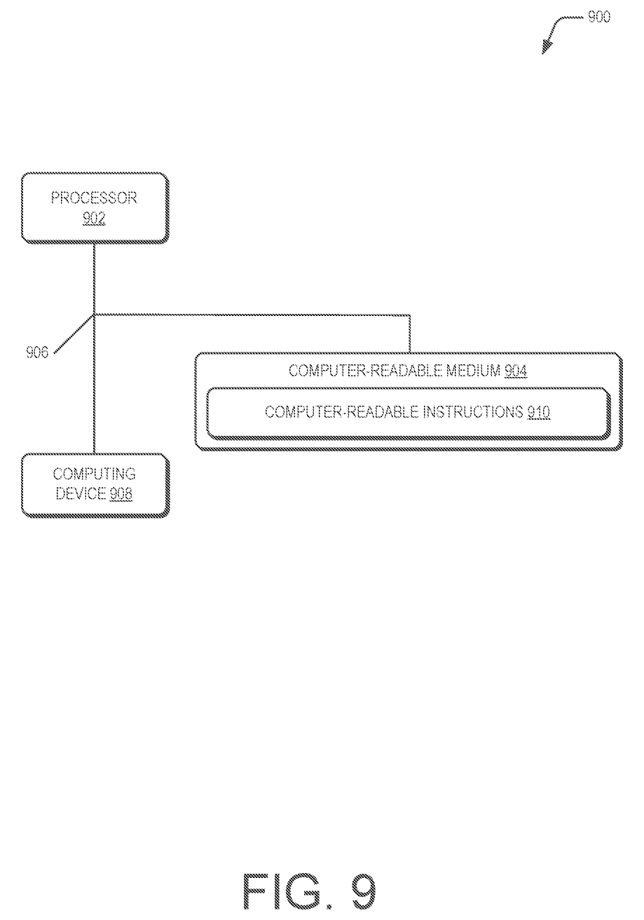

FIG. 9 illustrates a non-transitory computer-readable medium for facilitating management of the BAS, in accordance with an example of the present subject matter.

In an example, the computing environment 900 includes processor 902 communicatively coupled to a non-transitory computer readable medium 904 through communication link 906. In an example implementation, the computing environment 900 may be, for example, the BAS 102. In an example, the processor 902 may have one or more processing resources for fetching and executing computer-readable instructions from the non-transitory computer readable medium 904. The processor 902 and the non-transitory computer readable medium 904 may be implemented, for example, in the BAS 102.

The non-transitory computer readable medium 904 may be, for example, an internal memory device or an external memory. In an example implementation, the communication link 906 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 904 includes a set of computer readable instructions 910 which may be accessed by the processor 902 through the communication link 906 and subsequently executed for facilitating management of the BAS. The processor(s) 902 and the non-transitory computer readable medium 904 may also be communicatively coupled to a computing device 908 over the network.

Referring to FIG. 9, in an example, the non-transitory computer readable medium 904 includes computer readable instructions 910 that cause the processor 902 to receive a query related to a building services system from a plurality of building services systems present within a premises. The BAS may control operations of the plurality of building services systems. Further, the query may be for determining a command sequence to be implemented on the BAS for controlling the building services system.

The instructions 910 may then cause the processor 902 to determine a query type corresponding to the query. The query type may comprise at least one of: conceptual query and instructional query, where the conceptual query relates to the technical specification of the building services system and the instructional query relates to the operation of the building services system.

In an example, prior to determining the query type, the instructions 910 may cause the processor 902 to augment the query based on a context of the query. In the example, the query may be received from an operator corresponding to a workbench associated with the BAS, and the instructions 910 may cause the processor 902 to determine the context of the query based on a user profile of the operator.

The instructions 910 may then cause the processor 902 to identify a set of data sources comprising query resolution data related to the building services system based on the query type, where the query resolution data is usable for determining a response to the query.

The instructions 910 may then cause the processor 902 to retrieve the query resolution data related to the building services system from the set of data sources. The query resolution data may comprise at least one of: technical specification related to the building services system, community Q&A corresponding to the building services system comprising empirical queries related to the building services system and responses to the empirical queries, developer documentation associated with the BAS comprising developer comments related to a plurality of features of the BAS, and a preliminary response to the query generated by a service help desk corresponding to the BAS.

Thereafter, the instructions 910 may cause the processor 902 to analyse the query resolution data related to the building services system with respect to the query using a Large Language Model (LLM) for determining the response to the query.

Subsequently, the instructions 910 may cause the processor 902 to determine requirement of at least one of an operational parameter associated with the building services system and logs associated with the operational parameter for determining the response to the query.

The instructions 910 may then cause the processor 902 to retrieve at least one of the operational parameter and the logs associated with the operational parameter from a workbench associated with the BAS.

The instructions 910 may then cause the processor 902 to update the query resolution data by including at least one of the operational parameter and the logs associated with the operational parameter to generate updated query resolution data.

Thereafter, the instructions 910 may cause the processor 902 to analyze the updated query resolution data with respect to the query using the LLM for determining the response to the query. Subsequently, the instructions 910 may cause the processor 902 to return the response to the query.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method implemented by a Building Automation System (BAS), the method comprising:
receiving, by the BAS, a query related to a building services system from a plurality of building services systems present within a premises, wherein the BAS controls operations of the plurality of building services systems;
determining, by the BAS, a query type corresponding to the query;
identifying, by the BAS, a set of data sources comprising query resolution data related to the building services system based on the query type, wherein the query resolution data is usable for determining a response to the query;
retrieving, by the BAS, the query resolution data related to the building services system from the set of data sources;
analyzing, by the BAS, the query resolution data related to the building services system with respect to the query using a Large Language Model (LLM) for determining the response to the query;
returning, by the BAS, the response to the query.

2. The method as claimed in claim 1, wherein the query type comprises at least one of: conceptual query and instructional query, wherein the conceptual query relates to technical specifications of the building services system and the instructional query relates to operations of the building services system.

3. The method as claimed in claim 1, wherein the query resolution data comprises at least one of: technical specification related to the building services system, community Q&A corresponding to the building services system comprising empirical queries related to the building services system and responses to the empirical queries, developer documentation associated with the BAS comprising developer comments related to a plurality of features of the BAS, and a preliminary response to the query generated by a service help desk corresponding to the BAS.

4. The method as claimed in claim 1, wherein prior to determining the query type, the method comprises augmenting the query based on a context of the query.

5. The method as claimed in claim 4, wherein the query is received from an operator corresponding to a workbench associated with the BAS, and wherein the context of the query is determined based on a user profile of the operator.

6. The method as claimed in claim 1, wherein the analyzing comprises:
determining requirement of at least one of an operational parameter associated with the building services system and logs associated with the operational parameter for determining the response to the query;
transmitting a request to a workbench associated with the BAS for at least one of the operational parameter and the logs associated with the operational parameter;
receiving at least one of the operational parameter and the logs associated with the operational parameter; and
updating the query resolution data by including at least one of the operational parameter and the logs associated with the operational parameter to generate updated query resolution data; and
analyzing the updated query resolution data with respect to the query using the LLM for determining the response to the query.

7. The method as claimed in claim 1, wherein the query is for determining a command sequence to be implemented on the BAS for controlling the building services system.

8. A Building Automation System (BAS) comprising:
at least one processor and at least one memory storing instructions that, when executed by the at least one processor, cause the BAS at least to:
receive a query related to a building services system from a plurality of building services systems present within a premises, wherein the BAS controls operations of the plurality of building services systems;
determine a query type corresponding to the query;
identify a set of data sources comprising query resolution data related to the building services system based on the query type, wherein the query resolution data is usable for determining a response to the query;
retrieve the query resolution data related to the building services system from the set of data sources;
analyze the query resolution data related to the building services system with respect to the query using a Large Language Model (LLM) for determining the response to the query;
return the response to the query.

9. The BAS as claimed in claim 8, wherein the query type comprises at least one of: conceptual query and instructional query, wherein the conceptual query relates to technical specification of the building services system and the instructional query relates to operations of the building services system.

10. The BAS as claimed in claim 8, wherein the query resolution data comprises at least one of: technical specification related to the building services system, community Q&A corresponding to the building services system comprising empirical queries related to the building services system and responses to the empirical queries, developer documentation associated with the BAS comprising developer comments related to a plurality of features of the BAS, and a preliminary response to the query generated by a service help desk corresponding to the BAS.

11. The BAS as claimed in claim 8, wherein prior to determining the query type, the at least one processor causes the BAS to augment the query based on a context of the query.

12. The BAS as claimed in claim 11, wherein the query is received from an operator corresponding to a workbench associated with the BAS, and wherein the at least one processor causes the BAS to determine the context of the query based on a user profile of the operator.

13. The BAS as claimed in claim 8, wherein prior to returning the response to the query, the at least one processor causes the BAS to:
determine requirement of at least one of an operational parameter associated with the building services system and logs associated with the operational parameter for determining the response to the query;
transmit a request to a workbench associated with the BAS for at least one of the operational parameter and the logs associated with the operational parameter;
receive at least one of the operational parameter and the logs associated with the operational parameter;
update the query resolution data by including at least one of the operational parameter and the logs associated with the operational parameter to generate updated query resolution data; and
analyze the updated query resolution data with respect to the query using the LLM for determining the response to the query.

14. The BAS as claimed in claim 8, wherein the query is for determining a command sequence to be implemented on the BAS for controlling the building services system.

15. A non-transitory computer-readable medium comprising instructions that, when executed by at least one processor, cause the at least one processor to perform operations comprising:
receive a query related to a building services system from a plurality of building services systems present within a premises;
determine a query type corresponding to the query;
identify a set of data sources comprising query resolution data related to the building services system based on the query type, wherein the query resolution data is usable for determining a response to the query;
retrieve the query resolution data related to the building services system from the set of data sources;
analyze the query resolution data related to the building services system with respect to the query using a Large Language Model (LLM) for determining the response to the query;
determine requirement of at least one of an operational parameter associated with the building services system and logs associated with the operational parameter for determining the response to the query;
retrieve at least one of the operational parameter and the logs associated with the operational parameter from a workbench associated with a Building Automation System (BAS), wherein the BAS controls operations of the plurality of building services systems;
update the query resolution data by including at least one of the operational parameter and the logs associated with the operational parameter to generate updated query resolution data;
analyze the updated query resolution data with respect to the query using the LLM for determining the response to the query;
return the response to the query.

16. The non-transitory computer readable medium as claimed in claim 15, wherein the query type comprises at least one of: conceptual query and instructional query, wherein the conceptual query relates to technical specifications of the building services system and the instructional query relates to operations of the building services system.

17. The non-transitory computer readable medium as claimed in claim 15, wherein the query resolution data comprises at least one of: technical specification related to the building services system, community Q&A corresponding to the building services system comprising empirical queries related to the building services system and responses to the empirical queries, developer documentation associated with the BAS comprising developer comments related to a plurality of features of the BAS, and a preliminary response to the query generated by a service help desk corresponding to the BAS.

18. The non-transitory computer readable medium as claimed in claim 15, wherein prior to determining the query type, the instructions cause the processor to augment the query based on a context of the query.

19. The non-transitory computer readable medium as claimed in claim 18, wherein the query is received from an operator corresponding to a workbench associated with the BAS, and wherein the instructions cause the processor to determine the context of the query based on a user profile of the operator.

20. The non-transitory computer readable medium as claimed in claim 15, wherein the query is for determining a command sequence to be implemented on the BAS for controlling the building services system.
